(19) United States
(12) Patent Application Publication
(10) Pub. No.: US 2023/0256447 A1
(43) Pub. Date: Aug. 17, 2023

(54) A MICROFLUIDIC TESTING APPARATUS

(71) Applicant: Nanosynex Ltd, Tel Aviv (IL)

(72) Inventors: Micha ROSEN, Tzur Hadassah (IL); Michelle PATKIN NEHRER, Netanya (IL); Elad MOR, Mazkeret Batya (IL); Julien MEISSONNIER, Tzur Hadassah (IL); Jonathan AVESAR, San Diego, CA (US); Alexey SHATALOV, Petah Tikva (IL); Dan DURLACHER, Nice (FR)

(73) Assignee: Nanosynex Ltd, Tel Aviv (IL)

(21) Appl. No.: 18/015,536

(22) PCT Filed: Jul. 15, 2021
(86) PCT No.: PCT/IL2021/050867

§ 371 Date: Jan. 11, 2023

Related U.S. Application Data
(60) Provisional application No. 63/052,466, filed on Jul. 16, 2020.

(51) Int. Cl. B01L 3/00

(52) U.S. Cl. CPC B01L 3/502784; B01L 2300/0883; B01L 2300/0877; B01L 2300/0893; B01L 2300/0896; B01L 2400/0487; B01L 2400/084

(57) ABSTRACT

A microfluidic apparatus and methods thereof. The Apparatus having a flat and thin substrate, the substrate including at least one microfluidic testing device, each device with: plurality of Stationary Nanoliter Droplet Array (SNDA) components; a common inlet port and a distribution manifold, configured to enable an introduction of a fluid into all the primary channels; plurality of individual inlet ports, each coupled to a different primary channel, configured to enable an individual introduction of a fluid into its associated primary channel; and one or more outlet ports and optionally a collecting manifold, configured to evacuate liquid and/or gas flowing out thereof.

### FIELD OF THE INVENTION

The present invention relates to microfluidic testing devices.

### BACKGROUND OF THE INVENTION

Microfluidic devices that are designed to hold nanoliter-sized droplets of liquids in separate nano-wells, have been proven to be of use in the execution of various biological and chemical tests and procedures. In a typical procedure, two or more fluids are introduced successively into the device via one or more inlets. The nano-wells are then examined, e.g., visually by: a microscope, an automated image analysis system, or other visualization tools, to determine results of any interactions between the successively introduced liquids, or effects on cells that are suspended in one of the introduced liquids.

### SUMMARY OF THE INVENTION

There is provided, according to some embodiments of the present invention, a new apparatus microfluidic testing apparatus comprising a flat and thin substrate, the substrate comprising at least one microfluidic testing device, each device comprising:
plurality of Stationary Nanoliter Droplet Array (SNDA) components; each SNDA component comprising:
   a primary channel;
   one or two secondary channels, located respectively on one or both sides of the primary channel; and
   plurality of nano-wells, arranged along the primary channel, each nano-well:
      configured to accommodate a droplet of fluid;
      opens to the primary channel;
      connected via one or more vents to one of the secondary channels; the vents are configured to enable passage of gas only, from the nano-wells to the secondary channel;
a single inlet port and a single distribution manifold, configured to enable an introduction of a sample fluid into all the SNDAs;
plurality of individual inlet ports, each coupled to a different primary channel, configured to enable an individual introduction of a testing fluid into its associated primary channel; and
one or more outlet ports and optionally a collecting manifold, configured to evacuate fluid out of the device.

According to some embodiments, each SNDA further comprises an individual metering chamber, coupled in fluid communication between the distribution manifold and its associated primary channel, configured to temporarily accommodate a predetermined amount of sample fluid.

According to some embodiments, each of the metering chambers comprises a flow stopper at its primary channel end-side, configured to allow the passage of the fluid sample into its associated primary channel, only above a predetermined pressure; such that when said predetermined pressure is provided via the distribution manifold, all primary channels are simultaneously loaded.

According to some embodiments, each of the metering chambers comprises a flow restriction at its primary channel end-side, configured to prevent liquid flow from its associated primary channel towards the metering chamber.

According to some embodiments, the flow restriction is characterized by a predetermined ratio between the area of the flow restriction S_{Metering_Restriction} and the flow area S_{Primary_Flow} of the primary channel.

According to some embodiments, the metering chamber opening to the distribution manifold is restricted, characterized by a ratio between the area of the opening S_{Metering_Opening} and the surface area S_{Metering_Faces} of the metering chamber faces; configured to reduce an energy barrier for a droplet shearing, such that a sheared fluid is retained as a droplet within the metering chamber.

According to some embodiments, the nano-well's opening to the primary channel is restricted, characterized by a ratio between the area of the opening S_{Well_Opening} and the surface area S_{Well_Faces} of the nano-well's faces; configured to reduce an energy barrier for a droplet shearing, such that a sheared fluid is retained as a droplet within the nano-well.

According to some embodiments, both the distribution manifold and the individual inlet ports, are coupled proximal to a first end of the primary channels, such that fluid's flow within the primary channel is always in same direction.

According to some embodiments, the device further comprising at least one liquid reservoir, configured to collect a predetermined amount of liquid, wherein the collected liquid serves as a vapor source.

According to some embodiments, at least one SNDA component further comprises said liquid reservoir, coupled between:
the SNDA's primary channel, at second end thereof, and optionally its one or two associated secondary channels, and
the device's collecting manifold;
   said liquid reservoir is configured to collect liquid, flowing out of its associated primary channel, up to a predetermined amount, before it enables its flow towards the device's collecting manifold.

According to some embodiments, the configuration of each of the metering chambers, to temporarily accommodate said predetermined amount of sample fluid, is selected to avoid an overflow of its associated SNDA liquid reservoir.

According to some embodiments, the SNDA's liquid reservoir comprises funnel configuration at inlet and/or outlet thereof, configured to enable laminar liquid flow therewithin.

According to some embodiments, each of the liquid reservoirs, is further configured to prevent or at least partially inhibit convection and advection from one primary channel to another.

According to some embodiments, at least one SNDA component further comprises said liquid reservoir configuration as a predetermined number of nano-wells, proximal to the first end and/or last end of its associated primary channel.

According to some embodiments, said predetermined nano-wells are significantly larger in surface and/or deeper than the rest of the nano-wells, configured to accommodate a significantly larger amount of liquid.

According to some embodiments, said liquid reservoir is coupled between the distribution manifold outlet port and the end of distribution manifold, the end which is proximal to said outlet port; said liquid reservoir is configured to collect liquid, flowing out of distribution manifold, up to a predetermined amount, before it enables its flow towards the outlet port.

According to some embodiments, the device further comprises at least one flow stopper, configured to allow passage of liquid therethrough, only above a predetermined pressure threshold.

According to some embodiments, at least one of the liquid reservoirs comprises said flow stopper, therefore liquid is enabled to leave said reservoir, only above a predetermined pressure threshold.

According to some embodiments, the liquid reservoir associated with the distribution manifold further comprises said flow stopper, coupled between: the distribution manifold and the liquid reservoir, therefore liquid is enabled to leave said distribution manifold, only above a predetermined pressure threshold, which is selected to enable the filling of all nano-wells, before flowing towards the liquid reservoir.

According to some embodiments, at least one of the SNDA components further comprises said flow stopper, coupled between: the primary channel at second end and the liquid reservoir, therefore liquid is enabled to leave said primary channel, only above a predetermined pressure threshold, which is selected to enable the filling of all nano-wells, before flowing towards the liquid reservoir.

According to some embodiments, the plurality of the SNDA components are aligned parallel to one another and are laterally displaced relative to one another, to form a rectangular configuration.

According to some embodiments, all of the SNDA components are substantially identical.

According to some embodiments, the substrate comprises:
a microfluidic side comprising engraving of the microfluidic testing device, according to according to any of the above-mentioned embodiments; and
a port side comprising:
   a main inlet, coupled with the common inlet port;
   a positive pressure (PP) port, configured to be in communication via a pressure path engraved on the substrate's microfluidic side, with the main inlet, wherein the positive pressure is configured to enable the liquid's flow and/or a shearing process;
   plurality of testing inlets, each coupled with a different individual inlet port of the device; and
   outlets, coupled to the outlet ports;
      wherein the apparatus further comprising a cover film, configured to seal the upper surface of the microfluidic side of the substrate; the cover film is transparent, at least at the nano-wells section/s.

According to some embodiments, at least some of the substrate's port side inlets and outlets are configured to be sealed with a cap and/or communicate with a valve.

According to some embodiments, at least one of the substrate's port side outlets, is configured to be coupled with a negative-pressure (NP) device, configured to:
apply simultaneous negative pressure to at least some of the secondary channels, via the device's outlet port and the collecting manifold; and/or
apply simultaneous negative pressure to evacuate the device's distribution manifold, via the device's outlet port.

According to some embodiments, the substrate's port side main inlet further comprising a fluid receiving cup and a sealing lid, configured to seal or expose the receiving cup; the receiving cup is configured to be in communication with the positive pressure port, via the pressure path; the receiving cup comprising:
a fluid chamber, configured to collect fluid inserted via its open side, when the sealing lid is at open position;
a flow stopper, configured to allow passage of the liquid therethrough, from the liquid chamber towards the device's common inlet port, only above a predetermined pressure threshold; and
a pressure path configured to allow pressure communication between the fluid chamber and the PP device, via the PP port and via the communication path, when the sealing lid is at its closed position, such that when a pressure is provided above said predetermined pressure threshold, the liquid is inserted into the device via its common inlet port.

According to some embodiments, the fluid chamber comprises a liquid reservoir, configured to avoid liquid communication with the flow stopper and therefore keep a predetermined amount of liquid that serves as a vapor source.

There is provided, according to some embodiments of the present invention, a new method of using the apparatus according to any one of the above-mentioned embodiments; the method comprising:
loading a sample liquid into the common inlet port, while the individual testing inlets ports are closed and/or sealed off and while the outlet port of the distribution manifold is open;
applying a second pressure, while the outlet port of the distribution manifold is open, configured to push excessive liquid out of the distribution manifold, while maintaining the sample liquid in the metering chambers; wherein the second pressure is not sufficient to enable passage of liquid out of the metering chambers towards their associated primary channels;
closing the outlet port of the distribution manifold, and applying a first pressure configured to push the sample liquid from the metering chambers into the nano-wells, via the primary channels; wherein the first pressure is not sufficient to enable passage out of the primary channels' 2^{nd} end;
closing the outlet port of the distribution manifold, and applying a third pressure, configured to shear the excessive liquid out of primary channels, while sheared liquid droplets are maintained within the nano-wells; and
examining the nano-wells' liquid droplets, optionally treated by a former accommodated testing material.

According to some embodiments, the step of examining further comprising heating the device to a predetermined temperature, configured for incubation of the liquid droplets, accommodated in the nano-wells.

According to some embodiments, the method further comprising a step of embossing the device's substrate together with the cover film, at predetermined fluidic path locations, wherein the embossing is configured to seal microchannels, thereby preventing evaporation of the accommodated sample droplets; the step of embossing takes place after the step of applying the third pressure for shearing the excessive fluid out of primary channels, while sheared droplets are maintained within the nano-wells, and before the step of heating the device; the embossing is configured to block fluidic pathways, such that said embossed fluidic pathways are permanently blocked.

According to some embodiments, the method further comprising steps that are prior to the liquid sample loading:
loading individual treatment solutions, each into a different individual port, and accordingly into its associated primary channel;
closing and/or sealing off the individual inlet ports and closing the outlet port of the distribution manifold and applying a fourth, configured to push the individual treatment solutions into the nano-wells; wherein the fourth pressure is not sufficient to allow passage out of the primary channels' 2^{nd} end; and
applying a fifth pressure configured to shear the treatment solutions out of primary channels 2^{nd} end, while sheared droplets are maintained within the nano-wells.

According to some embodiments, the method further comprising applying a negative pressure via the outlet port of the colleting manifold, configured to evacuate the collected treatment solutions.

According to some embodiments, the method further comprising treating the droplets of the treatment solution, while within the nano-wells.

According to some embodiments, the method further comprising a step of embossing the device's substrate together with the cover film, at predetermined locations configured to seal fluidic pathway between the each of the individual inlet ports and its associated primary channel; this step of embossing takes place after the step loading the individual treatment solutions, and before the step of loading the sample liquid, such that said embossed fluidic pathways are permanently blocked.

There is provided, according to some embodiments of the present invention, a new apparatus comprising a flat and thin substrate, the substrate comprising at least one microfluidic testing device, each device comprising:
plurality of Stationary Nanoliter Droplet Array (SNDA) components; each SNDA component comprising:
   a straight-line primary channel;
   one or two straight-line secondary channels, located respectively on one or both sides of—and parallel to—the primary channel; and
   plurality of nano-wells, arranged along the primary channel, each nano-well:
      configured to accommodate a nanoliter droplet of fluid;
      opens to the primary channel;
      connected via one or more vents to one of the secondary channels; the vents are configured to enable passage of gas only, from the nano-wells to the secondary channel;
a common inlet port and a distribution manifold, configured to enable an introduction of a fluid into all the primary channels;
plurality of individual inlet ports, each coupled to a different primary channel, configured to enable an individual introduction of a fluid into its associated primary channel; and
one or more outlet ports and optionally a collecting manifold, configured to evacuate liquid and/or gas flowing out thereof.

According to some embodiments, both the distribution manifold and the individual inlet ports, are coupled proximal to a first end of the primary channels, such that fluid's flow within the primary channel is always in same direction.

According to some embodiments, the device further comprising at least one liquid reservoir (e.g., a sacrificial liquid reservoir), configured to collect a predetermined amount of liquid, wherein the collected liquid serves as a vapor source, used to at least partially mitigate evaporation of the droplets accommodated in the nano-wells.

According to some embodiments, at least one SNDA component further comprises the liquid reservoir, coupled between:
the SNDA's primary channel, at second end thereof, and optionally its one or two associated secondary channels, and
the device's collecting manifold;
the liquid reservoir is configured to collect liquid, flowing out of its associated primary channel, up to a predetermined amount, before it enables its flow towards the device's collecting manifold.

According to some embodiments, the SNDA's liquid reservoir comprises funnel configuration at inlet and/or outlet thereof, configured to enable laminar liquid flow therewithin.

According to some embodiments, each of the liquid reservoirs, is further configured to prevent or at least partially inhibit convection and advection from one primary channel to another.

According to some embodiments, at least one SNDA component further comprises the liquid reservoir configuration as a predetermined number of nano-wells, proximal to the first end of its associated primary channel.

According to some embodiments, the predetermined nano-wells are significantly larger and/or deeper than the rest of the nano-wells, configured to accommodate a significantly larger amount of liquid.

According to some embodiments, the liquid reservoir is coupled between the distribution manifold outlet port and the end of distribution manifold, the end which is proximal to the outlet port; the liquid reservoir is configured to collect liquid, flowing out of distribution manifold, up to a predetermined amount, before it enables its flow towards the outlet port.

According to some embodiments, the device further comprises at least one flow stopper, configured to allow passage of liquid therethrough, only above a predetermined pressure threshold.

According to some embodiments, at least one of the liquid reservoirs comprises the flow stopper, therefore liquid is enabled to leave the reservoir, only above a predetermined pressure threshold.

According to some embodiments, the liquid reservoir associated with the distribution manifold further comprises the flow stopper, coupled between: the distribution manifold and the liquid reservoir, therefore liquid is enabled to leave the distribution manifold, only above a predetermined pressure threshold, which is selected to enable the filling of all nano-wells, before flowing towards the liquid reservoir.

According to some embodiments, at least one of the SNDA components further comprises the flow stopper, coupled between: the primary channel at second end and the liquid reservoir, therefore liquid is enabled to leave the primary channel, only above a predetermined pressure threshold, which is selected to enable the filling of all nano-wells, before flowing towards the liquid reservoir.

According to some embodiments, the plurality of the SNDA components are aligned parallel to one another and are laterally displaced relative to one another, to form a rectangular configuration.

According to some embodiments, all of the SNDA components are substantially identical.

According to some embodiments, the substrate comprises:
a microfluidic side comprising engraving of the microfluidic testing device, according to any one of the above-mentioned embodiments; and
a port side comprising:
   a main inlet, coupled with the common inlet port;
   a positive pressure (PP) port, configured to be in communication via a pressure path engraved on the substrate's microfluidic side, with the main inlet, wherein the positive pressure is configured to enable the liquid's flow and/or a shearing process;
   plurality of testing inlets, each coupled with a different individual inlet port of the device; and
   outlets, coupled to the outlet ports;
      wherein the apparatus further comprising a bonded sealing film, configured to seal the microfluidic side of the substrate; the sealing film is transparent, at least at the nano-wells section/s.

According to some embodiments, at least some of the substrate's port side inlets and outlets are configured to be sealed with a cap and/or communicate with a valve.

According to some embodiments, at least one of the substrate's port side outlets, is configured to be coupled with a negative-pressure (NP) device, configured to:
apply simultaneous negative pressure to at least some of the secondary channels, via the device's outlet port and the collecting manifold; and/or
apply simultaneous negative pressure to evacuate the device's distribution manifold, via the device's outlet port.

According to some embodiments, the substrate's port side main inlet further comprising a fluid receiving cup and a sealing lid, configured to seal or expose the receiving cup; the receiving cup is configured to be in communication with the positive pressure port, via the pressure path; the receiving cup comprising:
a fluid chamber, configured to collect fluid inserted via its open side, when the sealing lid is at open position;
a flow stopper, configured to allow passage of the liquid therethrough, from the liquid chamber towards the device's common inlet port, only above a predetermined pressure threshold; and
a pressure path configured to allow pressure communication between the fluid chamber and the PP device, via the PP port and via the communication path, when the sealing lid is at its closed position, such that when a pressure is provided above the predetermined pressure threshold, the liquid is inserted into the device via its common inlet port.

According to some embodiments, the fluid chamber comprises a liquid reservoir, configured to avoid liquid communication with the flow stopper and therefore keep a predetermined amount of liquid that serves as a vapor source.

According to some embodiments, the device further comprising plurality of individual metering chambers, each coupled between the distribution manifold and a different primary channel of a different SNDA component configured to temporarily accommodate a predetermined amount of fluid.

According to some embodiments of the invention, a new method of using the apparatus according to any one of the above-mentioned embodiments; the method comprising:
loading a liquid sample into the fluid receiving cup and into the fluid chamber, via its open sealing lid;
closing the sealing lid, the lid/s of all the testing inlets and the lid of the distribution manifold outlet; and applying a first pressure configured to push at least most of the fluid within the fluid chamber into the device's common inlet and therefore into the nano-wells; wherein the first pressure is not sufficient to allow passage out of the primary channels' 2^{nd} end, nor the passage out of the distribution manifold towards their associated liquid reservoir;
opening the lid of the distribution manifold outlet; and applying a second pressure, configured to push the fluid from the distribution manifold towards the primary channel and the distribution manifold's associated liquid reservoir; wherein the second pressure is not sufficient to allow passage out of the primary channels towards their associated liquid reservoirs;
closing the lid of the distribution manifold outlet; and applying a third pressure configured to shear the fluid out of primary channels and into their associated liquid reservoirs, while sheared droplets are maintained within the nano-wells; and
examining the nano-wells' fluid droplets, formed by the sample fluid and optionally together with a prior first fluid.

According to some embodiments, the method further comprising heating the device to a predetermined temperature configured for incubation of the fluid droplets, accommodated in the nano-wells, and such that the liquid reservoirs allow their accommodated liquid to vapor, while maintaining the fluid droplets in the nano-wells.

According to some embodiments, the method further comprising steps which are prior to the sample loading:
loading individual treatment solutions each into a different testing port and accordingly into its associated primary channel;
closing the sealing lid, the lid/s of all the testing inlets and the lid of the distribution manifold outlet; and applying a fourth pressure configured to push the individual treatment solutions into the nano-wells; wherein the fourth pressure is not sufficient to allow passage out of the primary channels' 2^{nd} end and into to their associated liquid reservoirs; and
applying a fifth pressure configured to shear the treatment solutions out of primary channels and into their associated liquid reservoirs, while sheared droplets are maintained within the nano-wells.

According to some embodiments, the method further comprising applying a negative pressure via the substrate's port side outlet and colleting manifold, configured to drain the collected treatment solutions out of the liquid reservoirs.

According to some embodiments, the method further comprising treating the droplets of the treatment solution, while within the nano-wells.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an example of an apparatus having a substrate with two microfluidic testing devices, according to some embodiments of the invention;

FIGS. 2A and 2B schematically illustrate an example of an apparatus having a microfluidic testing device having liquid reservoirs, according to some embodiments of the invention;

FIGS. 3A, 3B, 3C, 3D, 3E, 3F and 3G schematically illustrate an example of an apparatus having a microfluidic testing device having liquid reservoirs and flow stoppers, according to some embodiments of the invention;

FIGS. 4A, 4B, 4C and 4D schematically illustrate the port side of the apparatus's substrate, according to some embodiments of the invention;

FIG. 5 schematically demonstrates method steps for using the apparatus, according to some embodiments of the invention;

FIGS. 6A, 6B and 6C schematically illustrate another example of the apparatus, according to some embodiments of the invention;

FIGS. 6D, 6E, 5F and 6G schematically illustrate another example of the apparatus, according to some embodiments of the invention;

FIGS. 6H and 6I schematically illustrate a metering chamber, according to some embodiments of the invention;

FIG. 7 schematically demonstrates method steps for using the apparatus shown in FIGS. 6A-6G, according to some embodiments of the invention;

FIGS. 8A and 8B schematically illustrate the apparatus shown in FIGS. 6A-6C, having embossed fluid paths; and

FIGS. 9A, 9B and 9C schematically illustrate another example of the apparatus, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth, in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. As used herein, in one embodiment the term “about” refers to ±10%. In another embodiment, the term “about” refers to ±9%. In another embodiment, the term “about” refers to ±9%. In another embodiment, the term “about” refers to ±8%. In another embodiment, the term “about” refers to ±7%. In another embodiment, the term “about” refers to ±6%. In another embodiment, the term “about” refers to ±5%. In another embodiment, the term “about” refers to ±4%. In another embodiment, the term “about” refers to ±3%. In another embodiment, the term “about” refers to ±2%. In another embodiment, the term “about” refers to ±1%.

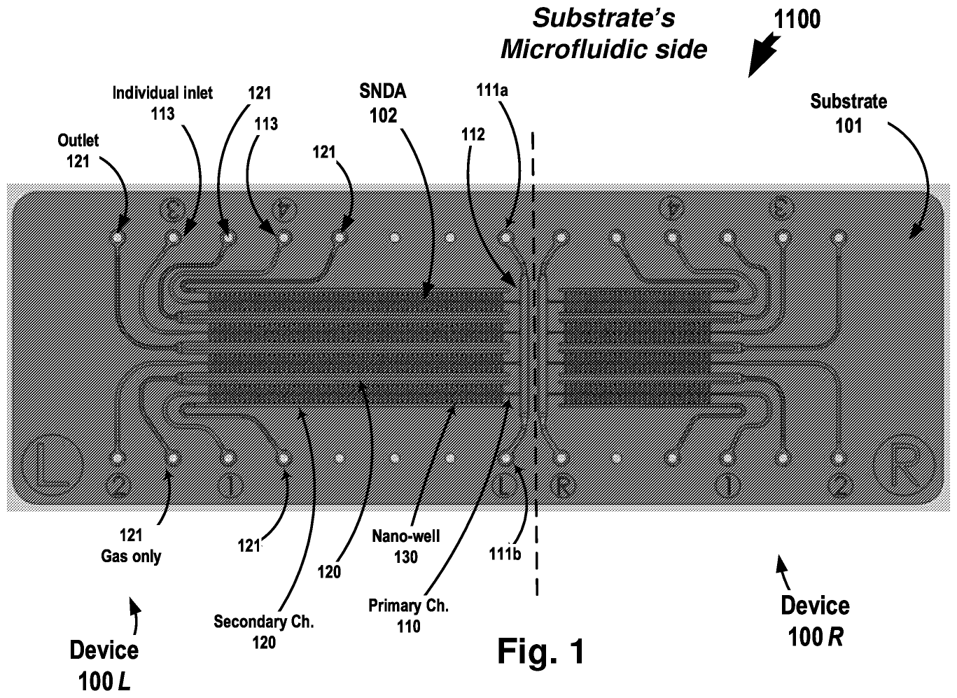

In accordance with some embodiments of the invention, and as demonstrated at least in FIGS. 1, 2A, 3A, 6A and 6D, a microfluidic testing apparatus (1100,1200,1300,1600,1800) is provided comprising a flat and thin substrate (101,201,301,601,801); the substrate comprising at least one microfluidic testing device (100L,100R,200,300,600,800), wherein each testing device comprises:
plurality of Stationary Nanoliter Droplet Array (SNDA) components (102,202,302,602); each SNDA component comprising:
   a primary channel (110,210,310);
      one or two secondary channels (120,220,320), located on one- or both-sides of the primary channel, respectively; and
   plurality of nano-wells (130,230,330), arranged along the primary channel, each nano-well:
      configured to accommodate a nanoliter droplet of fluid (e.g., liquid);
      opens to the primary channel (231,331);
      connected via one or more vents (232,332) to one of the secondary channels; the vents are configured to enable passage of gas only, from the nano-well to the secondary channel; such that when fluid (e.g., liquid) is introduced into the nano-well, via the primary channel, the originally accommodated gas (e.g., air) is evacuated out of the nano-well, via the vent/s and into the secondary channel;
a common inlet port (111a,111b,211,311,611) and a common distribution manifold (112,212,312,612,812), configured to enable an introduction of a fluid (e.g., liquid) into all the primary channels of the testing device; according to some embodiments, the common distribution manifold can comprise a form of: a pipe, a channel or a chamber, branching into several openings;
plurality of individual inlet ports (113,213,313), each coupled to a different SNDA component, configured to enable an individual introduction of a fluid into its associated primary channel; and
one or more outlet ports (111a,111b,113,121,221s,221e,321s,321e) and optionally a common colleting manifold (222,322), configured to collect fluid coming out of the plurality of SNDAs and to evacuate the fluid via the outlet port/s.

According to some embodiments, each of the SNDA's primary channels comprises a straight-line configuration. According to some embodiments, each of the SNDA's secondary channels comprises a straight-line configuration. According to some embodiments, each of the SNDA's primary and secondary channels comprises a straight-line configuration. According to some embodiments, the SNDA's straight-line primary- and secondary-channels are configured to be parallel one to another. According to some embodiments, all SNDAs are configured to be parallel one to another.

According to some embodiments, the volume of each of the nano-well (130,230,330) is selected between 0.015 and 0.002 μL.

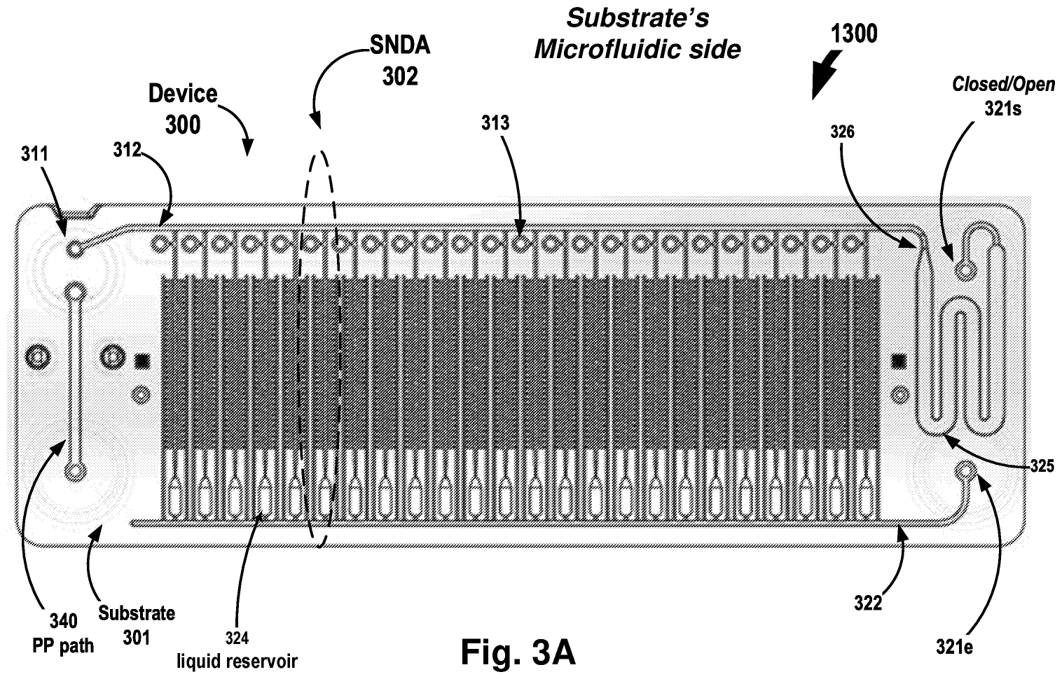

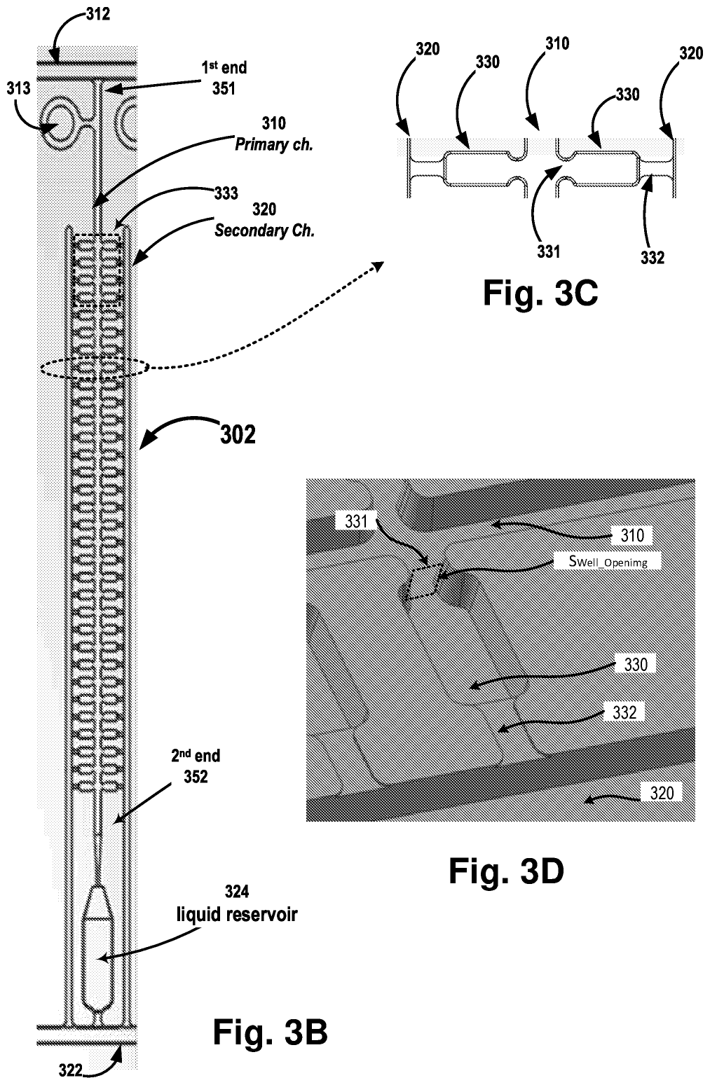

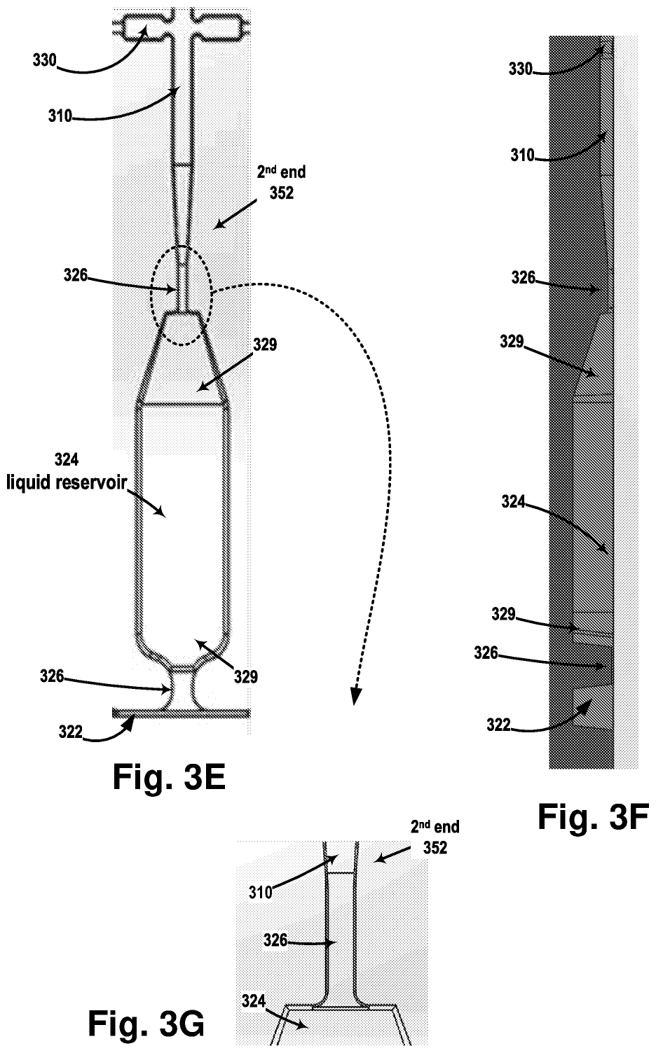

According to some embodiments, the nano-well's (330) opening to the primary channel is restricted and can comprise a neck configuration, as demonstrated in FIGS. 3C and 3D (331). The opening (331) (optionally a neck) to the primary channel (310) is characterized by a ratio between the area of the opening S_{Well_Opening} (331) and the surface area S_{Well_Faces} of the nano-well's faces (e.g., six faces), which is configured to reduce an energy barrier for a droplet shearing, such that a sheared fluid (e.g., liquid) is retained as a droplet within the nano-well (330). Other designs and sizes of nano-wells may be used, and accordingly their characterized opening. According to some embodiments, the ratio S_{Well_Faces}/S_{Well_Opening} is selected between 6 and 15. According to some embodiments, the ratio S_{Well_Faces}/S_{Well_Opening} is selected: about 5, or about 6, or about 7, or about 8, or about 9, or about 10, or about 11, or about 12, or about 13, or about 14, or about 15, and any combination thereof.

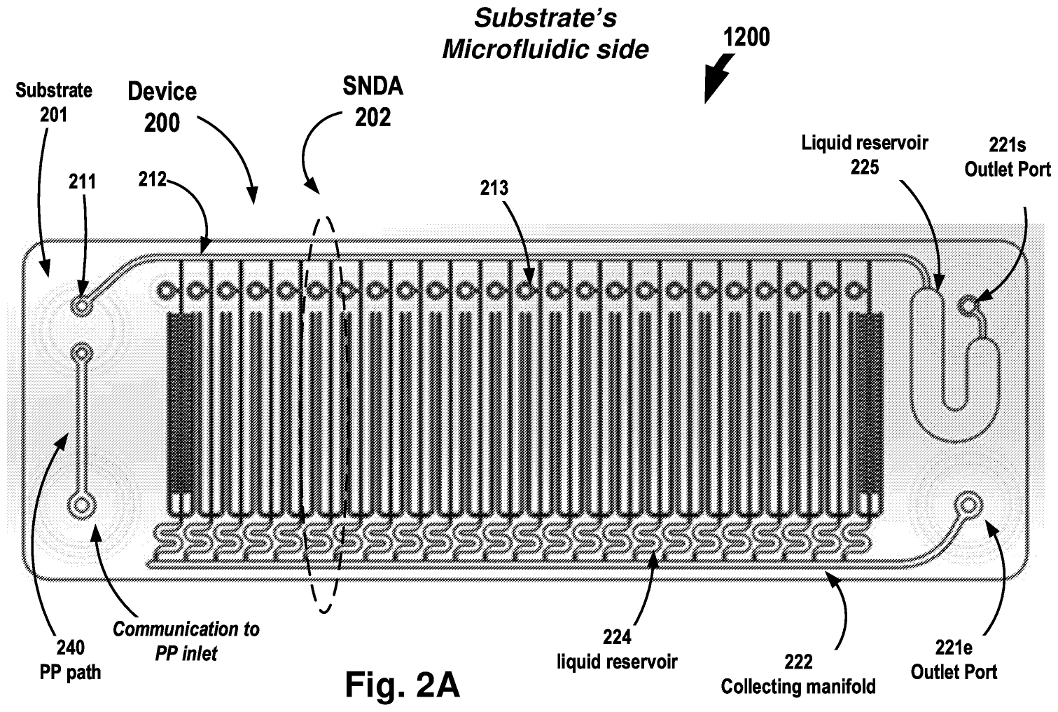

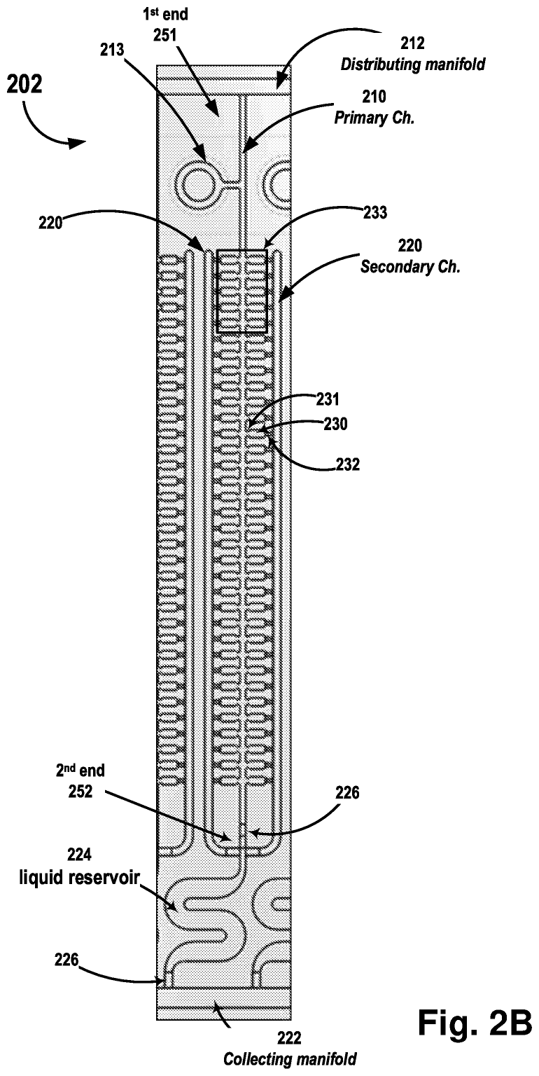

According to some embodiments, and as demonstrated in FIGS. 2A-2B and 3A-3B, both the distribution manifold (212,312) and the individual inlet ports (213,313), are coupled proximal to a first end (251,351) of the primary channels, such that fluid's flow within the primary channel is always in same direction. According to some embodiments, the flow in only one direction within the primary channel is configured to at least one of:
enable same duration of the fluid exposure to all nano-wells in the primary channel, and thereby same sterile environment;
minimize a gradient of a washing effect of the dissolved chemistries within the SNDA nano-wells, by enabling equal volumetric flow at the entrance of all the nano-wells;
minimize a cross contamination between SNDA components, by trapping the sheared primary channel fluid, at the effluent of each SNDA; and
any combination thereof.

According to some embodiments, the entire apparatus and its contained fluid are thermally controlled to a temperature of 36±1° C., for an optimal bacterial growth. It was evidenced that the liquid in the nano-wells, which are closer to a large gas volume (e.g., ports and manifolds), tend to evaporate, before the liquid in the rest of the SNDA component.

Accordingly, a configuration that can create at least one liquid buffer, between the SNDA nano-wells and the large air chambers of the apparatus, is required. It is therefore that, according to some embodiments, the device (200,300,600,800) further comprising at least one liquid reservoir, configured to collect a predetermined amount of liquid. According to some embodiments, the liquid reservoir is a sacrificial liquid reservoir, wherein the collected liquid serves as a vapor source, used to prevent the evaporation of the liquid accommodated within the nano-wells, at least during the apparatus's incubation and/or test period.

According to some embodiments and as demonstrated in FIGS. 2A-2B, 3A-3B and 3E, at least one SNDA component comprises the liquid reservoir (224,324), coupled between:
the SNDA's primary channel, at second end (252,352) thereof, and optionally its one or two associated secondary channels (220), and
the device's collecting manifold (222,322);
   the liquid reservoir (224,324) is configured to collect liquid, flowing out of its associated primary channel, up to a predetermined amount, before it enables its flow towards the device's collecting manifold (222,322). According to some embodiments, the volume of each liquid reservoir (224,324) is related to the volume of its associated primary channel (210,310). According to some embodiments, the volume of each liquid reservoir (224,324) is selected between about 0.4 μL to about 0.6 μL.

According to some embodiments, and as demonstrated in FIGS. 3A-3B and 3E, the SNDA component's liquid reservoir (324), is only coupled between:
the SNDA's primary channel, at second end (352) thereof, and
the device's collecting manifold (322);
   this connection does not include the secondary channel/s, in order to avoid contamination to primary channel from the secondary channel.

According to some embodiments, and as demonstrated in FIGS. 3A-3B and 3E, the SNDA's liquid reservoir (324) comprises a funnel configuration (329) at inlet and/or outlet thereof, configured to enable laminar liquid flow therewithin; such that liquid can leave before gas, at washing or shearing process.

According to some embodiments, each of the liquid reservoirs (224,324), is further configured to prevent, or at least partially inhibit, convection and advection from one primary channel to another, and therefore prevent, or at least inhibit, contamination between adjacent primary channels.

According to some embodiments, and as demonstrated in FIGS. 2A-2B and 3A-3B, at least one SNDA component further comprises the liquid reservoir configuration as a predetermined number of nano-wells (233,333), proximal to the first end (251,351) of its associated primary channel. According to some embodiments, about 25% nano-wells or less, of the total number of nano-wells, are configured to function as the liquid reservoir. According to some embodiments, those predetermined nano-wells (233,333) are significantly larger and/or deeper than the rest of the nano-wells, configured to accommodate a significantly larger amount of liquid, for a non-limiting example about twice the volume of the sum of the rest of the nano-wells.

According to some embodiments, and as demonstrated in FIGS. 2A and 3A, the liquid reservoir (225,325), also referred to as sample waste chamber, is coupled between:
the distribution manifold outlet port (221s,321s), and
the end of distribution manifold (212,312), the end which is proximal to the outlet port.

The sample waste chamber (225,325) is configured to collect liquid, flowing out of distribution manifold, up to a predetermined amount, before it enables its flow towards the outlet port (221s,321s).

According to some embodiments, and as demonstrated in FIGS. 2B, 3E, 3F and 3G, the device further comprises at least one flow stopper (226,326), configured to allow passage of liquid therethrough, only above a predetermined pressure threshold. According to some embodiments, the flow stopper comprises a form selected from: a bottle neck, a funnel, a sharp step, a conduit with a rapidly increasing/decreasing cross section area, and any combination thereof.

According to some embodiments, at least one of the liquid reservoirs comprises the flow stopper (226,326), therefore liquid is enabled to leave the reservoir, only above a predetermined pressure threshold.

According to some embodiments, the liquid reservoir (or sample waste chamber) (225,325), which is associated with the distribution manifold, further comprises the flow stopper (226,326), coupled between: the distribution manifold and the liquid reservoir, therefore liquid is enabled to leave the distribution manifold, only above a predetermined pressure threshold, which is selected to enable the filling of all nano-wells (via the primary channels), before flowing towards the liquid reservoir (225,325).

According to some embodiments, at least one of the SNDA components further comprises the flow stopper (226,326), coupled between:
the primary channel (310) at second end (352),
and the liquid reservoir (224,324),
   therefore, liquid is enabled to leave the primary channel, only above a predetermined pressure threshold, which is selected to enable the filling of all nano-wells, before flowing towards the liquid reservoir.

According to some embodiments, and as demonstrated in FIGS. 1, 2A, 3A, 6A and 6D, the plurality of the SNDA components are aligned parallel to one another and are laterally displaced relative to one another, to form a rectangular configuration. According to some embodiments, the configuration of all of the SNDA components is substantially identical.

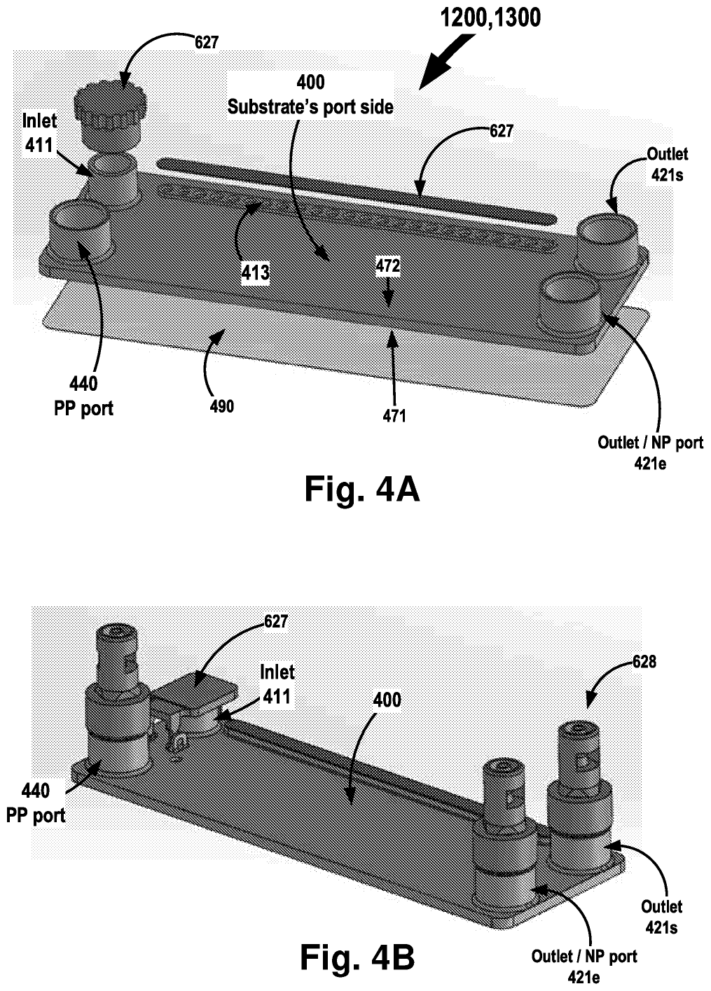

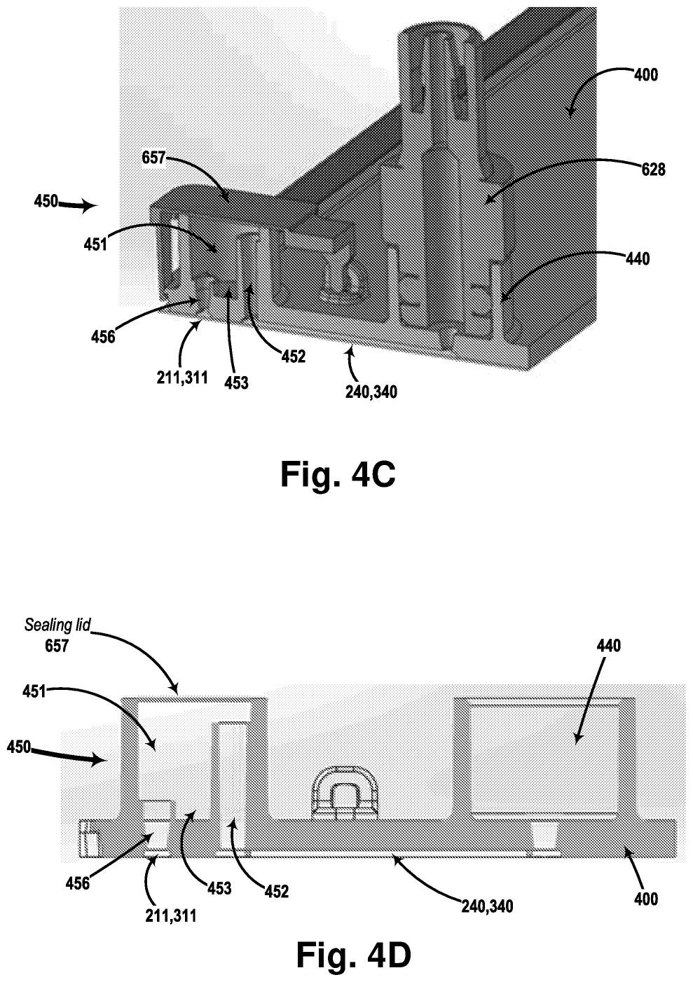

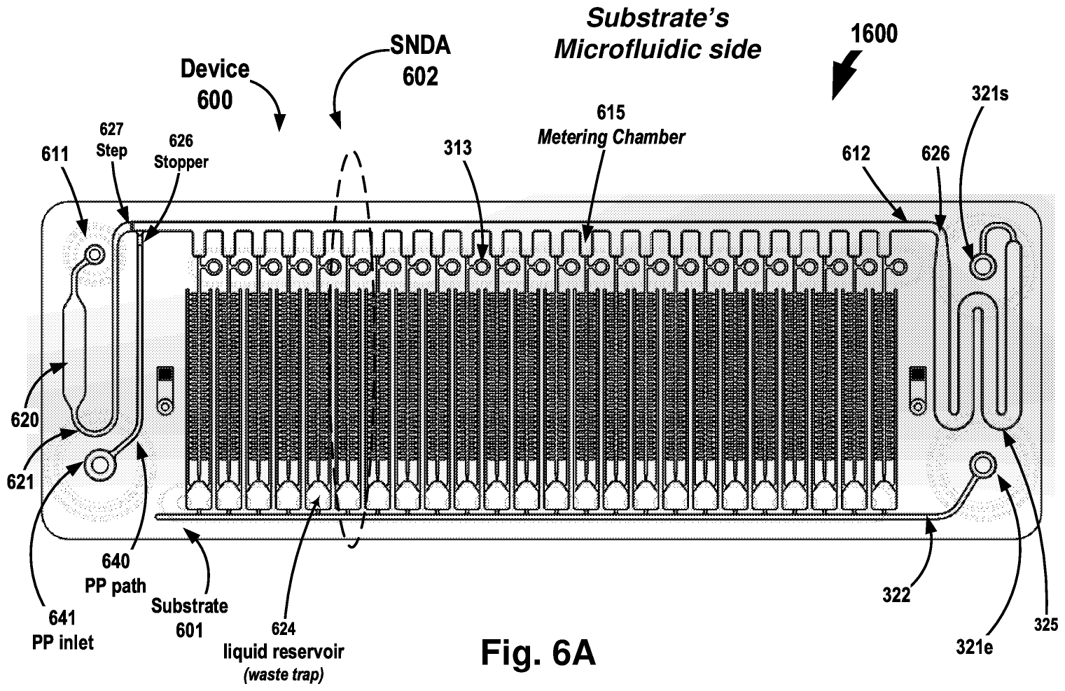

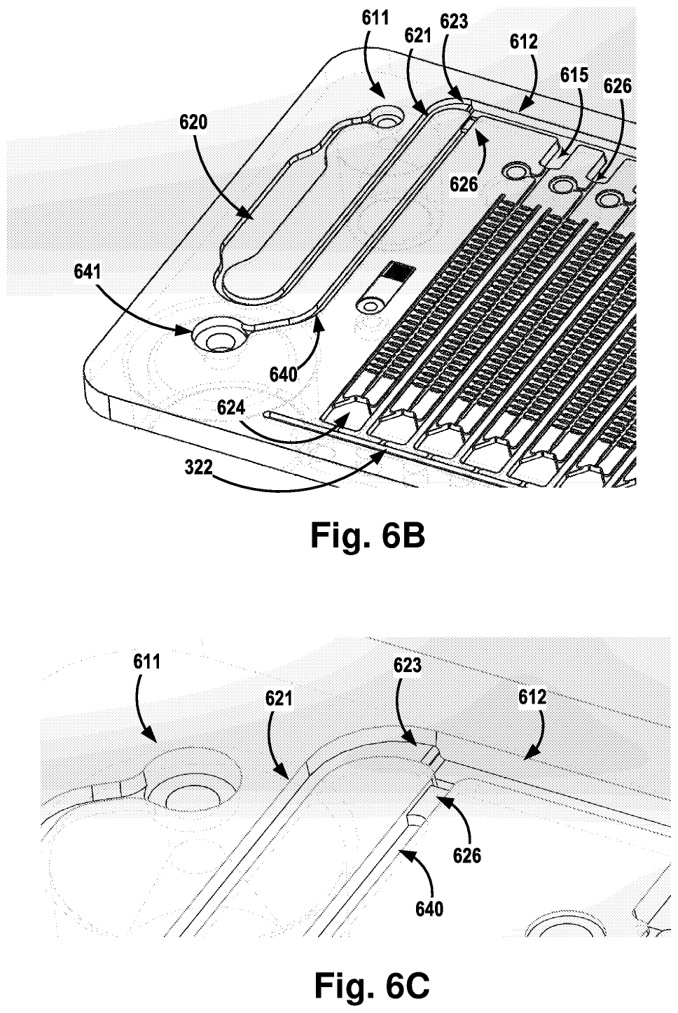

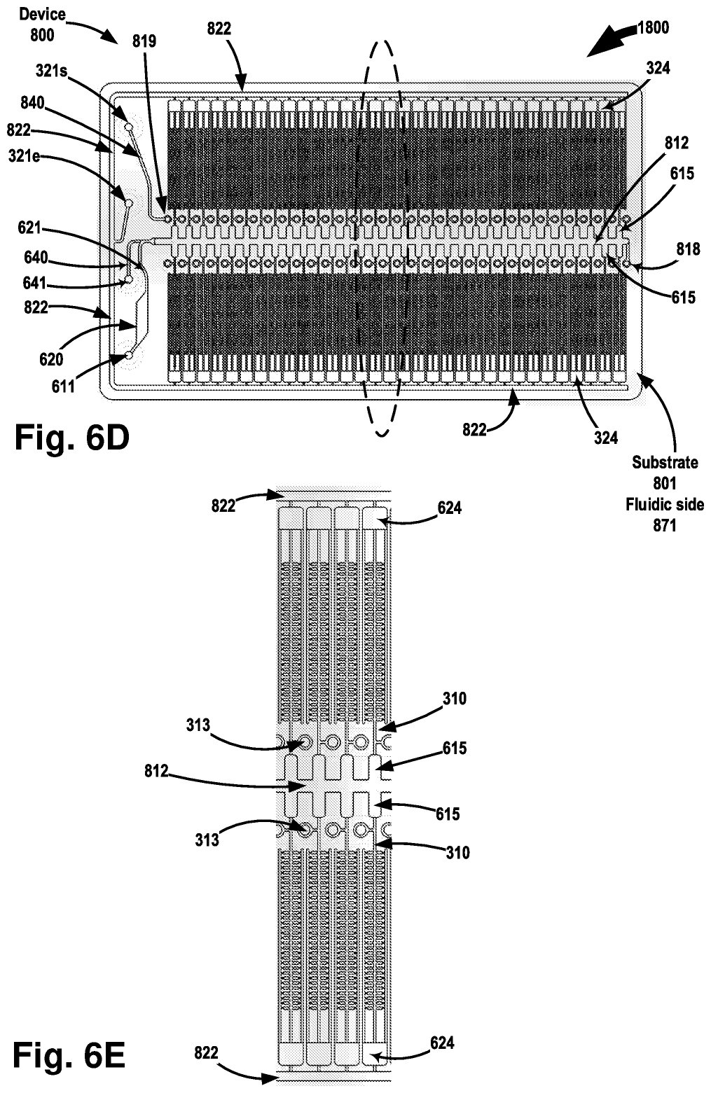

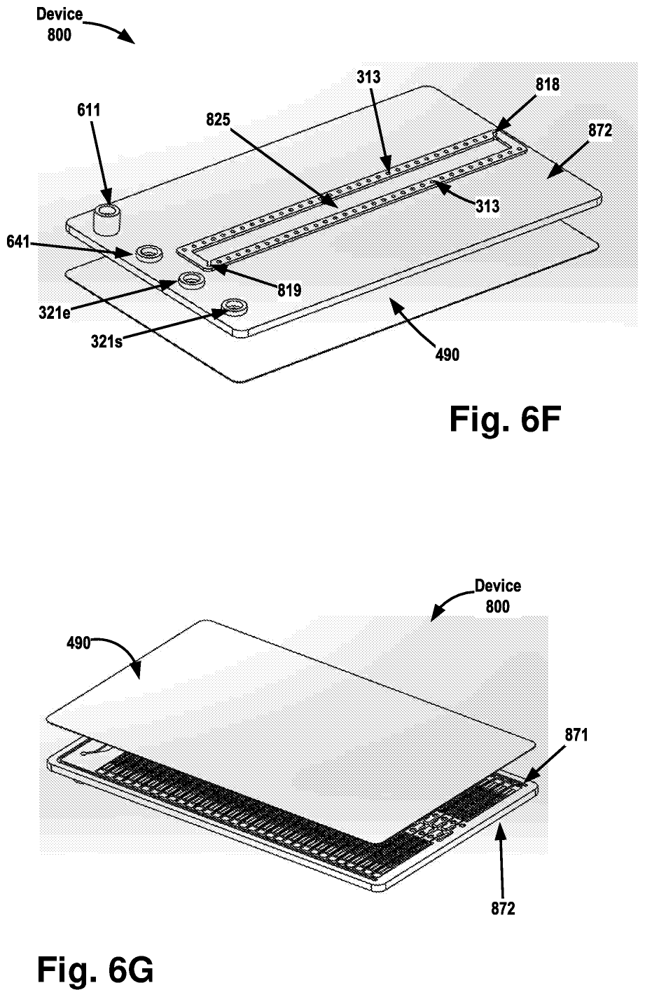

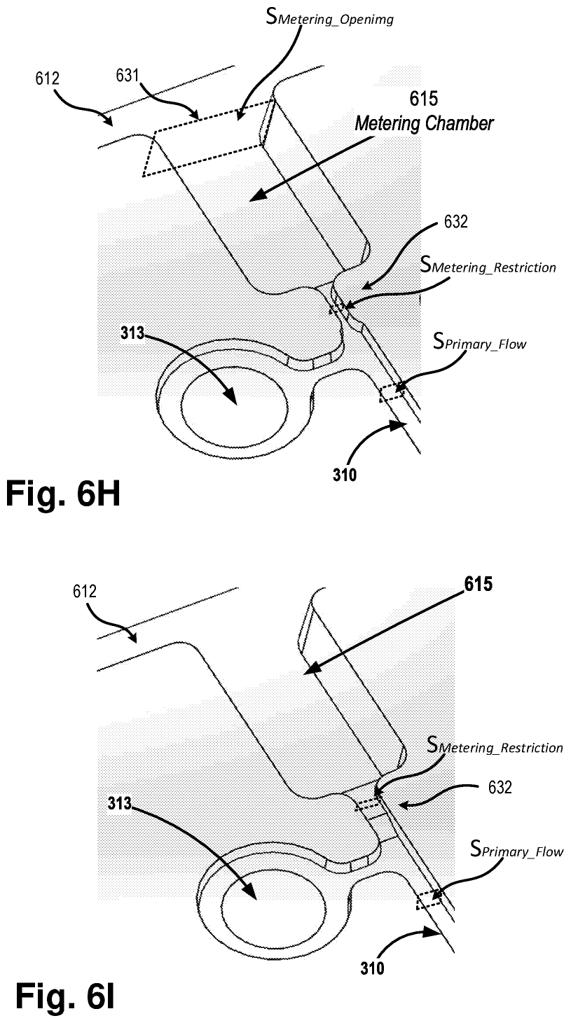

According to some embodiments, the apparatus's substrate (101,201,301, 601,801) comprises:
a microfluidic side, demonstrated in at least in FIGS. 1, 2A, 3A, 6A and 6D, comprising an engraving of the microfluidic testing device (100L,100R,200,300, 600,800), according to any one of the above-mentioned embodiments; and
a port side (400), as demonstrated at least in FIGS. 4A, 4B, 4C and 4D, comprising:
   a main inlet (411), fluid communication with the common inlet port (211,311,611), optionally configured to protrude out of the substrate's surface;
   a positive pressure (PP) port (440,641); optionally configured to protrude out of the substrate's surface; according to some embodiments, the PP port (440) is configured to be in fluid communication, via a pressure path (240 FIG. 2A, 340 FIG. 3A) engraved on the substrate's microfluidic side, with the main inlet (411), or in direct fluid communication with the distribution manifold (312,612), (641 via pressure path 640, as demonstrated in FIGS. 6A and 6D); according to some embodiments, the positive pressure is configured to enable the liquid's flow in the primary channels, and/or to enable a shearing process;
   plurality of testing inlets (413), optionally configured to protrude out of the substrate's surface port side (472); each testing inlet is coupled with a different individual inlet port (313) of the device (200,300,600,800); and
   outlets (421s,421e), coupled to the outlet ports (221s,321s,211e,321e) of the testing device.
wherein the apparatus further comprising a sealing film (490), configured to seal the microfluidic side (471,871) of the substrate; the sealing film is transparent, at least at the nano-wells section/s. According to some embodiments, the sealing film is bonded to the microfluidic side of the substrate.

According to some embodiments, and as demonstrated in FIG. 4B, at least some of the substrate's port side-inlets and -outlets are configured to be sealed with a cap (627) and/or communicate with a valve (628).

According to some embodiments, and as demonstrated in FIG. 4B, at least one of the outlets (421s,421e), is configured to be coupled with a negative pressure (NP) device, configured to:
apply simultaneous negative pressure to at least some of the secondary channels (220,320), via the device's outlet port (221e,231e), and to the collecting manifold (222,322); and/or
apply simultaneous negative pressure to evacuate the device's distribution manifold (212,312), via the device's outlet port (221s,231s).

According to some embodiments, and as demonstrated in FIGS. 4C and 4D, the substrate's port side main inlet (411) further comprising a fluid receiving cup (450) and a sealing lid (457), configured to seal or expose the receiving cup; the receiving cup is configured to be in communication with the positive pressure port (440), via the pressure path (240,340); the receiving cup comprising:
a fluid chamber (451), configured to collect fluid (e.g., liquid), inserted via its open side, when the sealing lid (457) is at an open position;
a flow stopper (456), configured to allow passage of the liquid therethrough, from the liquid chamber towards the device's common inlet port (211,311,611), only above a predetermined pressure threshold; and
a pressure path (452), configured to allow pressure communication between the fluid chamber (451) and the PP device, via the PP port (440) and via the communication path (240,340), when the sealing lid (457) is at its closed position, such that when a pressure is provided above the predetermined pressure threshold, the liquid is inserted into the device via its common inlet port (211,311).

According to some embodiments, the liquid chamber (421) comprises a liquid reservoir (453) (e.g., a sacrificial liquid reservoir), configured to avoid liquid communication with the flow stopper (456) and therefore keep a predetermined amount of liquid that serves as a vapor source.

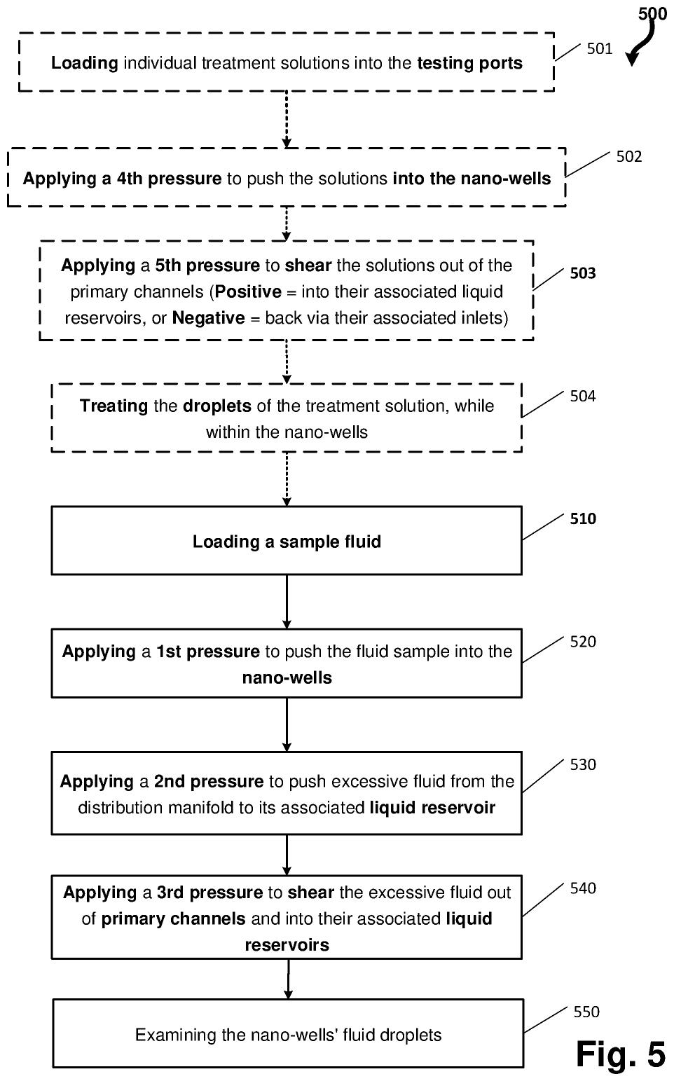

According to some embodiments, and as demonstrated in FIG. 5, a method is provided of using the apparatus (1200,1300 and optionally 1600,1800), according to any one of the above-mentioned embodiments; the method 500 comprising:
(510) loading a sample fluid (e.g., sample liquid) via the common inlet port (111a, 111b,211,311,611) and into the distribution manifold (312), while the individual testing inlets (313,413) are closed and/or sealed off and while the distribution manifold outlet (321s,421s) is open to ambient (atmospheric) pressure; according to some embodiments, via the fluid receiving cup (450) and into the fluid chamber (451), via its open sealing lid (457), optionally via a pipette;
(520) closing the distribution manifold outlet port (321s,421s); and applying a first (1^{st}) pressure via an inlet to the common distribution manifold (311 or 641) configured to push at least most of the sample fluid within the fluid chamber into the device's common inlet port (211,311) and therefore into the nano-wells, via the distribution manifold and the primary channels; wherein the first pressure is not sufficient to allow passage of the sample fluid out of the primary channels' 2′d end, nor the passage of the sample fluid out of the distribution manifold towards its associated liquid reservoir (224,324,225,325);
(530) opening the distribution manifold outlet port (321s,421s) to ambient (atmospheric) pressure; and applying a second (2^{nd}) pressure via an inlet to the common distribution manifold (311 or 641), configured to push excessive fluid from the distribution manifold (212,312) towards the primary channels (210,310) and the distribution manifold's associated liquid reservoir (225,325); wherein the second pressure is not sufficient to allow passage out of the primary channels towards their associated liquid reservoirs (224,324); according to some embodiments, the value of the first and the second pressures can be similar;
(540) closing off the distribution manifold outlet port from ambient (atmospheric) pressure; and applying a third (3^{rd}) pressure via an inlet to the common distribution manifold (311 or 641) configured to shear the excessive fluid out of primary channels (210,310) and into their associated liquid reservoirs (224,324), while sheared droplets are maintained within the nano-wells (230,330);
(550) examining the nano-wells' fluid droplets, formed by the sample fluid and optionally together with a former accommodated fluid/material (e.g., treatment solutions); according to some embodiments the examining is provided via at least one imaging device and at least one computing device, configured to examine and analyze the content of the droplets.

According to some embodiments, outlet port (321e,921e), located at the 2^{nd} end of the collecting manifold (322,939B), is kept open at any time, to allow fluid evacuation.

According to some embodiments, the method step of examining (550,750) further comprising heating the device (200,300) to a predetermined temperature; according to some embodiments, the heating temperature is selected from about 34° C. to about 37° C., configured for the incubation of the fluid droplets, accommodated in the nano-wells, and such that the liquid reservoirs allow their accommodated liquid to vapor, while maintaining the fluid droplets in the nano-wells.

According to some embodiments, the method further comprising steps, which are prior to the sample fluid loading (510):
(501) loading individual treatment solutions each into a different testing port (413) and/or inlet (213,313) and accordingly into its associated primary channel, optionally via individual pipettes, while the common inlet (311,611,641) is closed; according to some embodiments, some of the treatment solutions may be same, and some may be different from the others;
(502) applying a fourth (4^{th}) pressure via the different testing ports (413) configured to push the individual treatment solutions into the nano-wells; wherein the fourth pressure is not sufficient to allow passage out of the primary channels' 2^{nd} end and into their associated liquid reservoirs (224,324); and
(503) applying a fifth (5^{th}) pressure configured to shear the treatment solutions out of primary channels, while sheared droplets are maintained within the nano-wells (230,330);
   in case of a positive 5^{th} pressure, the excessive treatment solutions are pushed into their associated liquid reservoirs (224,324); the positive 5^{th} pressure can be applied via the common inlet (311 or 641), while the individual testing inlet/ports (313,413) are closed or sealed off, or that the positive 5^{th} pressure can be applied via the individual testing inlet/ports (313,413), while the common inlet (311,611,641) is closed; or
   in case of a negative 5^{th} pressure, applied via the individual testing inlet/ports while the common inlet (311,611,641) is closed, the excessive treatment solutions are pulled back and out via their associated individual inlets (213,313).

According to some embodiments, the method further comprising applying a negative pressure via the substrate's outlet (421e) and colleting manifold (222,322), configured to evacuate the collected treatment solutions out of the liquid reservoirs (224,324).

According to some embodiments, the method further comprising treating 504 droplets of the treatment solution. For a non-limiting example, heating the device (200,300) to a predetermined temperature, configured to dry or lyophilize the droplets of the treatment solution in the nano-wells. According to some embodiments, and as known in the art lyophilization process comprises freezing temperatures and vacuum. According to some embodiments, and as known in the art lyophilization process comprises drying.

According to some embodiments, and as demonstrated in FIGS. 6A, 6B, 6C, 6D 6E, 6F and 6G an apparatus (1600,1800) is provided, comprising a microfluidic device (600,800); the device is principally comprising most or at least some features and components as of apparatus (1300) and its device (300) as demonstrated in FIGS. 3A-3G.

According to some embodiments, the device (600,800) further comprises plurality of individual metering chambers (615). Each of the metering chambers is coupled between the common distribution manifold (612,812) and a different primary channel (310) of a different SNDA component (602), just before its individual inlet port (313). According to some embodiments, each of the metering chambers comprises a gradual or sharp change in cross section (623) at its primary channel end-side, accordingly the metering chambers (615) are configured to hold a predetermined amount of sample fluid (e.g., liquid), to be loaded into its associated the primary channel, when a predetermined pressure is applied from the distribution manifold; such that when said predetermined pressure is provided via the distribution manifold, all primary channels are simultaneously loaded. According to some embodiments, each of the metering chambers is configured to accommodate a predetermined amount of fluid (e.g., sample liquid), such that an overflow of its associated SNDA liquid reservoir (624) is prevented; for example, such an overflow may damage the shearing of the excessive fluid out of primary channels (310) and therefore contaminate the nano-wells (330) of that SNDA (302).

According to some embodiments, the metering chamber (615) opening to the distribution manifold is restricted and can comprise a neck configuration, as demonstrated in FIG. 6H (631). The opening (631) (optionally a neck) to the distribution manifold (312,612) is characterized by a ratio between the area of the opening S_{Metering_Opening} (631) and the surface area S_{Meterng_Faces} of the metering chamber faces (e.g., six faces), which is configured to reduce an energy barrier for a droplet shearing, such that a sheared fluid (e.g., liquid) is retained as a droplet within the metering chamber (615). Other designs and sizes of metering chambers may be used. According to some embodiments, the ratio S_{Metering_Faces}/S_{Metering_Opening} is selected between 6 and 15. According to some embodiments, the ratio S_{Metering_Faces}/S_{Metering_Opening} is selected: about 5, or about 6, or about 7, or about 8, or about 9, or about 10, or about 11, or about 12, or about 13, or about 14, or about 15, and any combination thereof.

According to some embodiments, the metering chamber's (615) opening to the primary channel (310) is restricted and comprises a flow restriction configuration (632), as demonstrated in FIGS. 6H and 6I (optionally a neck as in FIG. 6H, or a step as in FIG. 6I); the restriction is configured to prevent or at least impede liquid flow from the primary channel towards the metering chamber (615). This is an important feature configured to prevent or at least impend the flow of the various treatment solutions, loaded via their individual ports (313), from flowing into the mutual distribution manifold, via the metering chambers. According to some embodiments, the restriction (632) to the primary channel is characterized by a ratio between the area of the restriction (632) S_{Metering_Restriction} and the flow area S_{Primary_Flow} of the primary channel, as demonstrated in FIGS. 6H and 6I. According to some embodiments, the ratio S_{Metering_Restriction}/S_{Primary_Flow} is selected between: 0.2-0.8, or 0.3-0.7, or 0.4-0.6, and any combination thereof. According to some embodiments, the ratio S_{Metering_Restriction}/S_{Primary_Flow} is selected: about 0.2, or about 0.3, or about 0.4, or about 0.5, or about 0.6, or about 0.7, or about 0.8, and any combination thereof. According to some embodiments, the flow restriction can also function as a flow stopper (626) as mentioned above, configured to allow passage of liquid therethrough, only above a predetermined pressure threshold.

According to some embodiments, the device (600,800) further comprises a fluid reservoir (620) and a fluid path (621), between the common inlet port (611) and the distribution manifold (612,812); the fluid reservoir (620) is configured to:
serve as a vapor source, to prevent the evaporation of the liquid accommodated within the nano-wells, at least during the apparatus's incubation and/or test period; and/or
trap air that inserted via the common inlet port (611) and prevent its passage towards the distribution manifold (612,812).

According to some embodiments, the device (600,800) further comprises a pressure inlet (641) and a pressure path (640) in direct communication with the distribution manifold (612,812) (not via the common inlet port (611) and its liquid reservoir (620), configured to enable the application of a positive pressure to the distribution manifold. According to such embodiments, when a pressure is applied via the pressure inlet (641), the common inlet (611) should be closed. According to some embodiments, the connection between the pressure path (640) with the distribution manifold comprises a flow stopper (626), configured to prevent passage of sample fluid from the distribution manifold towards the pressure path (640), as demonstrated in FIGS. 6B and 6C.

Non limiting examples for some measures include at least one of:
the depth of the distribution manifold (312,612,812) is about 500 μm;
the depth of the fluid path (621) is about 300 μm; therefore a step (623) is provided between the fluid path (621) and the distribution manifold (612,812), configured to prevent the fluid from flowing back from the distribution manifold (612,812) into the fluid path (621);
the depth of the flow stopper (626) is selected between about 50-200 μm; configured to prevent passage of sample fluid from the distribution manifold (612,812) towards the pressure path (640).

According to some embodiments, devices (600,800) can be operated by any one of the above-mentioned method steps. According to some embodiments during the steps of sample loading (510, 520, 530) the plurality of individual metering chambers (615) are functioning as an integral part of the distribution manifold.

According to some embodiments, and as demonstrated for apparatus 1800 as in FIG. 6D and a closer view of the device (800) thereof as in FIG. 6E, the metering chambers (615) are configured to enable a bilateral use of the common distribution manifold (812), where the plurality if the SNDAs can be positioned at both sides thereof. According to such embodiments, the device (800) can have double the number of SNDAs and nano-wells, compared to the devices (300,600) as demonstrated in FIGS. 3A and 6A, while using a single sample inlet (611). The doubling of the number of SNDAs is enabled, as the metering chambers are configured to provide an accurate amount load- and a simultaneous load-into each of the primary channels. Further details in steps of method 700.

According to some embodiments, and as demonstrated in FIGS. 6D-6G, the common distribution manifold (812) is in fluid communication with its associated liquid reservoir (825), which is located on the substrate's (801) port side (872), via port (818); and wherein the distribution manifold associated liquid reservoir (825) is in fluid path (840) (located at fluidic side (871)) communication with the distribution manifold outlet port (321), via port (819). According to some embodiments, liquid reservoir (825) is engraved in the substrate's port side (872) and is covered by a film (not shown).

According to some embodiments, the configuration of device (800) as in FIGS. 6D-6G is configured to allow all inlets and outlets (611,641,321e,321s) of the device (800) to be adjacent at same side, as shown in FIG. 6F, which enables a much less complex use of the apparatus (1800). According to some embodiments, the loading and the treatment of the testing fluid is conducted at a provider site (a provider of the microfluidic apparatus; e.g., manufacture site), and the loading and analysis of the sample fluid is conducted at a client site (a user of the of the microfluidic apparatus), accordingly the provided features of apparatus (1800) where all outlets (611,641,321e,321s) are adjacent at same side (as shown in FIG. 6F) enables a much less complex and user-friendly operation, with double the number of tested nano-wells. According to some embodiments, the configuration of device (800) as in FIGS. 6D-6G is configured to allow a much larger number of nano-wells per given size of substrate.

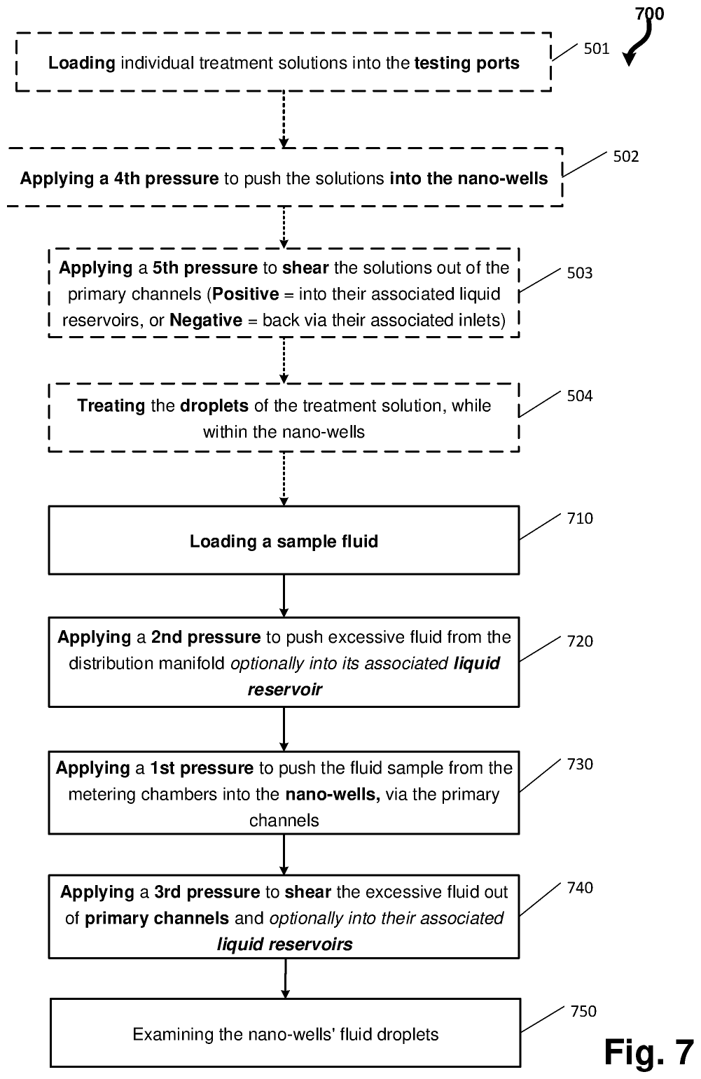

According to some embodiments, and as demonstrated in FIG. 7, a method is provided of using the apparatus (1600,1800) as demonstrated in FIGS. 6A-6G, according to any one of its above-mentioned embodiments, optionally after any one of the above-mentioned steps 501-504; the method 700 comprising:
(710) loading a sample fluid (e.g., sample liquid) into the common inlet port (611), while the individual testing inlets (313,413) are closed and/or sealed off and while the distribution manifold outlet port (321s,421s) is open; optionally via a pipette or via a dispensing apparatus, such as a syringe;
(720) applying a second (2^{nd}) pressure via an inlet to the common distribution manifold (311 or 641), while the distribution manifold outlet port (321s,421s) is open, configured to push excessive fluid out of the distribution manifold (612,812) towards the distribution manifold's associated liquid reservoir (325,825), while maintaining the fluid sample in the metering chambers (615); wherein the second pressure is not sufficient to allow passage out of the metering chambers towards their associated primary channels (310);
(730) closing the distribution manifold outlet port (321s,421s) and applying a first (1^{st}) pressure via an inlet to the common distribution manifold (311 or 641) configured to push the sample fluid from the metering chambers (615) into the nano-wells, via the primary channels (310); wherein the first (1^{st}) pressure is not sufficient to allow passage out of the primary channels' 2^{nd} end towards their associated liquid reservoir (624); according to some embodiments, the value of the first and the second pressure can be similar;
(740) closing the distribution manifold outlet port; and applying a third (3^{rd}) pressure via an inlet to the common distribution manifold (311 or 641) configured to shear the excessive fluid out of primary channels and into their associated liquid reservoirs (624), while sheared droplets are maintained within the nano-wells (330);
(750) examining the nano-wells' fluid droplets, formed by the sample fluid and optionally together with a former accommodated fluid/material (e.g., treatment solutions); according to some embodiments the examining is provided via at least one imaging device and at least one computing device, configured to examine and analyze the content of the droplets.

According to some embodiments, outlet port (321e,921e), located at the 2^{nd} end of the collecting manifold (322,939B), is kept open at any time, to allow fluid evacuation.

According to some embodiments, the methods 500 and/or 700 further comprising an embossing step. According to some embodiments, the term “embossing” refers to a process for producing a raised or a sunken design, at one or more predetermined points. According to some embodiments, process is provided by a stamping and/or pressing (optionality heat-pressing) process. According to some embodiments, the location of the embossing process is selected at a fluidic pathway, such that said path is blocked, and accordingly the selection of the size of embossing point. For example, by heat-pressing the film (490) to the substrates fluidic side (471,871) at one or more predetermined points of fluidic pathways, and/or by pressing an inlet/outlet and/or port, such that their fluidic path is permanently blocked. According to some embodiments, the embossing step/s are configured to prevent the evaporation of the fluid accommodated in the nano-wells.

According to some embodiments, the methods 500 and/or 700 comprising an embossing step (509,709), before the step of loading the fluid sample (510,710), configured to seal any fluidic path of all individual inlets (313) towards their associated primary channel, at microfluidic side (471,871) and/or to seal any fluidic path at all individual testing ports (413), at port side (472,872), (not shown). According to some embodiments, the step of embossing the individual inlets (313) is provided at a neck location thereof for example their pathways to their associated primary channel, therefore minimizing the size of the embossing point, while sealing their fluidic path. According to some embodiments, the step of embossing the individual inlets (313) and/or their pathways to their primary channel and/or the individual testing ports (413), is provided at the apparatus provider site.

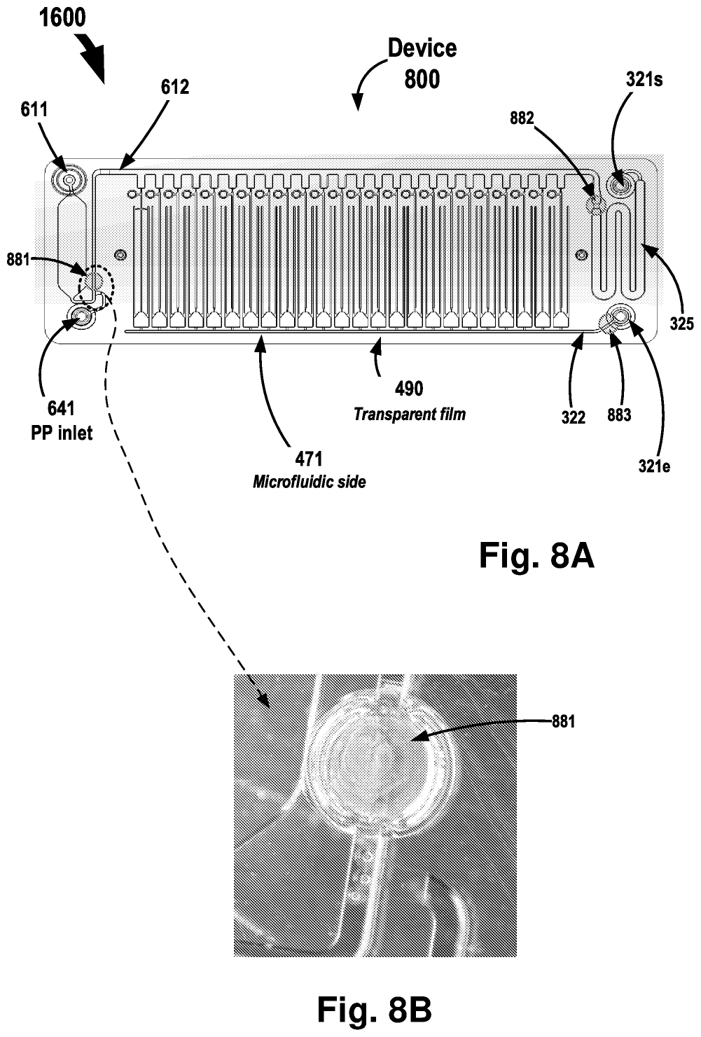

According to some embodiments, and as demonstrated in FIGS. 8A and 8B, the methods 500 and/or 700 comprising an embossing step, after the step of applying the third (3^{rd}) pressure (540,740) for shearing the excessive fluid out of primary channels (310), while sheared droplets are maintained within the nano-wells (230,330), and before the step of heating the device (600,800), configured to block fluidic pathways (881,882,883), such that said fluidic pathways are permanently blocked. According to some embodiments, the step of embossing the fluidic pathways is provided a neck location thereof, therefore minimizing the size of the embossing point, while sealing their fluidic path. According to some embodiments, the step of embossing the fluidic pathways, before the step of heating, is provided at the apparatus user's site (e.g., user's laboratory).

According to some embodiments, and as demonstrated for the configuration of apparatus (1600) in FIGS. 8A and 8B, only three embossing are required (for example at user site), in order to prevent the evaporation of the sample fluid in the nana-wells. As demonstrated in FIG. 8A, the three selected points can be:
Point (881), at the beginning of the distribution manifold (612), after the meeting of the inlet path (611) and the Positive pressure path (640), yet before the introduction with metering chamber (or if there isn't the primary channel) of the first SNDA in line; also shown via a picture in FIG. 8B;
Point (882), at the end of the distribution manifold (612), after the introduction with the last metering chamber (or if there isn't the last primary channel) of the SNDA, yet before its introduction with its associated liquid reservoir; and
Point (883), at the end of the collecting manifold (622), after collecting fluid from the last SNDA, yet before its introduction with its associated outlet (321e).

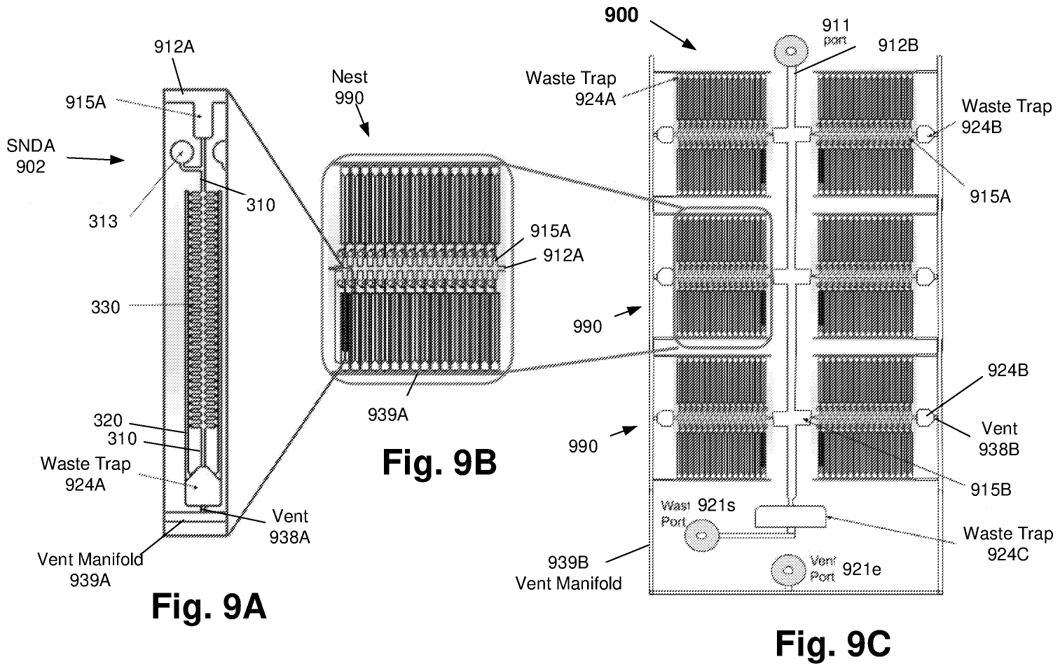

According to some embodiments, and as demonstrated in FIGS. 9A, 9B and 9C (in three zoom levels) another example of a microfluidic testing apparatus is provided, comprising a microfluidic testing device (900). The device (900) is principally comprising most or at least some features and components as of apparatuses (1300,1600,1800) and their devices (300,600,800) as demonstrated in FIGS. 3A-3G, 6A-61. According to some embodiments, device (900) comprises a configuration of plurality of SNDA nests (990) for a massive and simultaneous sample distribution, from a single sample loading port (911).

According to some embodiments, each SNDA's primary channel (310) is in fluid communication configured to be loaded with a sample fluid via its associated metering chamber (915A), at first end thereof; wherein each SNDA's metering chamber (915A) is in fluidic communication with its nest's (990) associated distribution manifold (912A).

According to some embodiments, each SNDA's primary channel (310) and secondary channels (320) are configured to evacuate fluid (gas and/or liquid) from their second end into their associated waste trap (e.g., liquid reservoir) (924A); wherein each SNDA's waste trap (924A) is in fluidic communication with its nest's (990) associated vent manifold (939A), via a vent (938A) configured to enable passage of gas only, from the waste trap (924A) to the vent manifold (939A), such that any liquid waste remains in the waste trap (924A).

According to some embodiments, the distribution manifold (912A) of each nest (990) of SNDA's is in fluidic communication configured to be loaded with a sample fluid via its associated second level metering chamber (915B), at first end thereof; wherein each nest's (990) second level metering chamber (915B) is in fluidic communication with a common second level distribution manifold (912B); the common second level distribution manifold (912B) is in fluidic communication, at first end thereof, configured to be loaded with sample fluid via the single inlet port (911); the common second level distribution manifold (912B) is configured to evacuate sample fluid from its second end into a third level waste trap (e.g., liquid reservoir) (924C), which is in fluidic communication with waste port 921s.

According to some embodiments, the distribution manifold (912A) of each nest (990) of SNDA's is configured to evacuate fluid (gas and/or liquid) from its second end into its associated second level waste trap (e.g., liquid reservoir) (924B); wherein each nest's (990) waste trap (924B) is in fluidic communication with a second level vent manifold (939B), via a vent (938B) configured to enable passage of gas only, from the second level waste trap (924B) to the second level vent manifold (939B), such that any liquid waste remains in the second level waste trap (924B); the second level vent manifold (939B) is in fluidic communication configured to evacuate gas via a vent port (921e).

According to some embodiments, each of the waste traps (924A,924B,924C), comprises a volume that is much larger than the volume it is aimed to trap (liquid waste), configured to prevent any overflow thereof. According to some embodiments, the volume of each of the waste traps (924A,924B,924C) is about between 1.2 and 1.7 larger than the volume it is aimed to trap (liquid waste). According to some embodiments, the volume of each of the waste traps (924A,924B,924C) is about twice the volume it is aimed to trap (liquid waste).

According to some embodiments, the provided various metering chambers and their configurations enable the demonstrated device (900) configuration of plurality of SNDA nests (990) aimed for a massive and simultaneous sample distribution, from a single sample loading port (911).

### EXAMPLES

Opening restrictions. Table 1 demonstrates examples for opening restrictions, configured to reduce an energy barrier for a droplet shearing, such that a sheared fluid (e.g., liquid) is retained as a droplet within the metering chamber (315,615) or within the nano-well (330), according to some of the above-mentioned embodiments.

TABLE 1

| | | | | | Opening | Ch./N.W. | | |
|---|---|---|---|---|---|---|---|---|
| | | | | | Surface | Surface | | |
| | Ch./N.W. | Ch./N.W. | Ch./N.W. | Ch./N.W. | Area | Area | Ch./N.W. | |
| | Open | Width | Depth | Length | S_{Opening} | S_{faces} | Vol | S_{faces}/ |
| | width | W(mm) | D(mm) | L(mm) | (mm\hat{ }2) | (mm\hat{ }2) | (mm\hat{ }3) | S_{Opening} |
| Metering | 1 | 1 | 0.5 | 2 | 0.5 | 3.5 | 1 | 7 |
| Chamber | | | | | | | | |
| (Ch.) | | | | | | | | |
| Nano- | 0.1 | 0.2 | 0.1 | 0.4 | 0.01 | 0.14 | 0.008 | 14 |
| Well (N.W.) | | | | | | | | |
| with neck | | | | | | | | |
| Nano- | 0.2 | 0.2 | 0.1 | 0.4 | 0.02 | 0.14 | 0.008 | 7 |
| well W/O | | | | | | | | |
| neck | | | | | | | | |

Nano-wells per field of view (FOV). According to some embodiments, and as demonstrated for example in FIGS. 3A and 3B, for apparatus (1300) each SNDA component (302) contains 64 nano-wells (330); each device (300) contains 24 SNDA components; accordingly, each device (300) contains 1536 nano-wells, per a FOV of 60 mm×15 mm=900 mm\hat{ }2; accordingly has nano-well density of 1536/900=1.7 nano-wells/mm\hat{ }2.

Examples for treatment solution components. According to some embodiments, a list of treatment solutions is provided that can be used to functionalize the micro fluidic testing apparatus, according to any one of the above-mentioned embodiments. According to some embodiments, the list of treatment solutions and their use footnotes (a-n) can be found in Table 6A of CLSI M100 ED31:2021 which can be accessed for free at http://em100.edaptivedocs.net/dashboard.aspx; “Table 6A. Solvents and Diluents for Preparing Stock Solutions of Antimicrobial Agents”. According to some embodiments, this functionalization process is performed in a production facility and is not done by the end user. According to some embodiments, the treatment solutions are loaded onto the device for drying.

Examples for treatment solution concentrations. According to some embodiments, the concentration of each antibiotic can be a two-fold dilution anywhere between 0.125 mg/L and 512 mg/L (see” Table 8A “Preparing Dilutions of Antimicrobial Agents to Be Used in Broth Dilution Susceptibility Tests” can be found in Table 6A of CLSI M100 ED31:2021 which can be accessed for free at http://em100.edaptivedocs.net/dashboard.aspx).

Sample solution components and concentrations. According to some embodiments, the sample solution can be composed of bacterial cells suspended in cation-adjusted mueller hinton broth (CAMBH), as demonstrated in Table 2. According to some embodiments, the concentration of bacteria can be anywhere between 1×10³ CFU/mL to 1×10⁹ CFU/mL. According to some embodiments, the standard inoculum concentration of 5×10⁵ CFU/mL is used. Product sheets for CAMBH (https://www.sigmaaldrich.com/deepweb/assets/sigmaaldrich/product/documents/312/461/90922dat.pdf) state that it contains the following components which are diluted in water and adjusted to a final pH of 7.3+/−0.2 at 25≅:

TABLE 2

| Component | Concentration (grams/liter) |
|---|---|
| Casein acid hydrolysate | 17.5 |
| Beef extract | 3.0 |
| Starch | 1.5 |

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A microfluidic testing apparatus comprising a flat and thin substrate, the substrate comprising at least one microfluidic testing device, each device comprising:
plurality of Stationary Nanoliter Droplet Array (SNDA) components; each SNDA component comprising:
a primary channel;
one or two secondary channels, located respectively on one or both sides of the primary channel; and
plurality of nano-wells, arranged along the primary channel, each nano-well:
configured to accommodate a droplet of fluid;
opens to the primary channel;
connected via one or more vents to one of the secondary channels; the vents are configured to enable passage of gas only, from the nano-wells to the secondary channel;
a single inlet port and a single distribution manifold, configured to enable an introduction of a sample fluid into all the SNDAs; and
one or more outlet ports and optionally a collecting manifold, configured to evacuate fluid out of the device;
wherein each SNDA further comprises an individual metering chamber, coupled in fluid communication between the distribution manifold and its associated primary channel, configured to temporarily accommodate a predetermined amount of sample fluid.

2. (canceled)

3. The apparatus of claim 1, wherein at least one of the following holds true:
each of the metering chambers comprises a flow stopper at its primary channel end-side, configured to allow the passage of the fluid sample into its associated primary channel, only above a predetermined pressure; such that when said predetermined pressure is provided via the distribution manifold, all primary channels are simultaneously loaded;
each of the metering chambers comprises a flow restriction at its primary channel end-side, configured to prevent liquid flow from its associated primary channel towards the metering chamber;
the metering chamber's flow restriction is characterized by a predetermined ratio between the area of the flow restriction S_{Metering_Restriction} and the flow area S_{Primary_Flow} of the primary channel.

4. (canceled)

5. (canceled)

6. The apparatus of claim 1, wherein the metering chamber opening to the distribution manifold is restricted, characterized by a ratio between the area of the opening S_{Metering_Opening} and the surface area S_{Metering_Faces} of the metering chamber faces; configured to reduce an energy barrier for a droplet shearing.

7. The apparatus of claim 1, wherein the nano-well's opening to the primary channel is restricted, characterized by a ratio between the area of the opening S_{Well_Opening} and the surface area S_{Well_Faces} of the nano-well's faces; configured to reduce an energy barrier for a droplet shearing.

8. (canceled)

9. The apparatus of claim 1, further comprising at least one liquid reservoir, configured to collect a predetermined amount of liquid, wherein the collected liquid serves as a vapor source.

10. The apparatus of claim 9, wherein at least one SNDA component further comprises the liquid reservoir, coupled between:
the SNDA's primary channel, at second end thereof, and optionally its one or two associated secondary channels, and
the device's collecting manifold;
the liquid reservoir is configured to collect liquid, flowing out of its associated primary channel, up to a predetermined amount, before it enables its flow towards the device's collecting manifold.

11. (canceled)

12. (canceled)

13. (canceled)

14. (canceled)

15. (canceled)

16. The apparatus of claim 9, wherein the liquid reservoir is coupled between the distribution manifold outlet port and the end of distribution manifold, the end which is proximal to the outlet port; the liquid reservoir is configured to collect liquid, flowing out of distribution manifold, up to a predetermined amount, before it enables its flow towards the outlet port.

17. (canceled)

18. (canceled)

19. (canceled)

20. (canceled)

21. (canceled)

22. (canceled)

23. The apparatus of claim 1, wherein the substrate comprises:
a microfluidic side comprising the microfluidic testing device/s, according to claim 1; and
a port side comprising:
a main inlet, coupled with the common inlet port; and
outlets, coupled to the outlet ports;
wherein the apparatus further comprising a cover film, configured to seal the upper surface of the microfluidic side of the substrate; the cover film is transparent, at least at the nano-wells section/s.

24. The apparatus of claim 23, wherein at least some of the substrate's port side inlets and outlets are configured to be sealed with a cap and/or communicate with a valve.

25. The apparatus of claim 23, wherein at least one of the substrate's port side outlets, is configured to be coupled with a negative-pressure (NP) device, configured to:
apply simultaneous negative pressure to at least some of the secondary channels, via the device's outlet port and the collecting manifold; and/or
apply simultaneous negative pressure to evacuate the device's distribution manifold, via the device's outlet port.

26. (canceled)

27. (canceled)

28. A method of using the apparatus according to claim 1; the method comprising:
loading a sample liquid into the common inlet port, and while the outlet port of the distribution manifold is open;
applying a second pressure, while the outlet port of the distribution manifold is open, configured to push excessive liquid out of the distribution manifold, while maintaining the sample liquid in the metering chambers; wherein the second pressure is not sufficient to enable passage of liquid out of the metering chambers towards their associated primary channels;
closing the outlet port of the distribution manifold, and applying a first pressure configured to push the sample liquid from the metering chambers into the nano-wells, via the primary channels; wherein the first pressure is not sufficient to enable passage out of the primary channels'-second end;
closing the outlet port of the distribution manifold, and applying a third pressure, configured to shear the excessive liquid out of primary channels, while sheared liquid droplets are maintained within the nano-wells; and
examining the nano-wells' liquid droplets, optionally treated by a former accommodated testing material.

29. The method of claim 28, wherein the step of examining further comprising heating the device to a predetermined temperature, configured for incubation of the liquid droplets, accommodated in the nano-wells.

30. The method of claim 28, further comprising a step of embossing the device's substrate together with the cover film, at predetermined fluidic path locations, wherein the embossing is configured to seal microchannels, thereby preventing evaporation of the accommodated sample droplets; the step of embossing takes place after the step of applying the third pressure for shearing the excessive fluid out of primary channels, while sheared droplets are maintained within the nano-wells, and before the step of heating the device; the embossing is configured to block fluidic pathways, such that the embossed fluidic pathways are permanently blocked.

31. (canceled)

32. (canceled)

33. (canceled)

34. (canceled)

35. The apparatus of claim 1, further comprising plurality of individual inlet ports, each coupled to a different primary channel, configured to enable an individual introduction of a testing fluid into its associated primary channel.

36. The apparatus of claim 23, further comprising plurality of testing inlets, each coupled with a different individual inlet port of the device.

37. The apparatus of claim 23, wherein the port side further comprises a positive pressure (PP) port, configured to be in communication via a pressure path engraved on the substrate's microfluidic side, with the main inlet, wherein the positive pressure is configured to enable the liquid's flow and/or a shearing process.

38. The apparatus of claim 37, wherein the substrate's port side main inlet further comprising a fluid receiving cup and a sealing lid, configured to seal or expose the receiving cup; the receiving cup is configured to be in communication with the positive pressure port, via the pressure path; the receiving cup comprising:
a fluid chamber, configured to collect fluid inserted via its open side, when the sealing lid is at open position;
a flow stopper, configured to allow passage of the liquid therethrough, from the liquid chamber towards the device's common inlet port, only above a predetermined pressure threshold; and
a pressure path configured to allow pressure communication between the fluid chamber and the PP device, via the PP port and via the communication path, when the sealing lid is at its closed position, such that when a pressure is provided above the predetermined pressure threshold, the liquid is inserted into the device via its common inlet port.

39. The method of claim 28, wherein the apparatus further comprising plurality of individual inlet ports, each coupled to a different primary channel, and wherein the step of loading is provided, while the individual inlets ports are closed and/or sealed off.

40. The method of claim 39, further comprising steps that are prior to the liquid sample loading:
loading individual treatment solutions, each into a different individual inlet port, and accordingly into its associated primary channel;
closing and/or sealing off the individual inlet ports and closing the outlet port of the distribution manifold and applying a fourth pressure, configured to push the individual treatment solutions into the nano-wells; wherein the fourth pressure is not sufficient to allow passage out of the primary channels' second end; and
applying a fifth pressure configured to shear the treatment solutions out of primary channels second end, while sheared droplets are maintained within the nano-wells.
